(19) United States
(12) Patent Application Publication
(10) Pub. No.: US 2026/0302646 A1
(43) Pub. Date: Oct. 1, 2026

(54) BASE STATION ANTENNAS HAVING INTEGRATED RADIATING ELEMENTS OF DIFFERENT FREQUENCY BANDS

(71) Applicant: Outdoor Wireless Networks LLC, Claremont, NC (US)

(72) Inventors: Jian Liu, Suzhou (CN); YueMin Li, Suzhou (CN); HongHui Chen, Suzhou (CN); Jiajia Ni, Suzhou (CN); Bo Huang, Suzhou (CN)

(21) Appl. No.: 19/477,552

(22) PCT Filed: Feb. 27, 2024
(86) PCT No.: PCT/US2024/017374

§ 371 Date: Oct. 22, 2025

(30) Foreign Application Priority Data
Apr. 24, 2023 (CN) 202310445519.X

(51) Int. Cl. H01Q 21/06; H01Q 1/24; H01Q 1/50; H01Q 15/00; H01Q 15/14

(52) U.S. Cl. CPC H01Q 21/062; H01Q 1/246; H01Q 1/50; H01Q 15/0013; H01Q 15/14

(57) ABSTRACT

Base station antennas are provided. A base station antenna includes a plurality of first-band dipole radiating elements and a plurality of second-band dipole radiating elements. A first of the second-band dipole radiating elements is mounted on a first of the first-band dipole radiating elements and/or different ones of the second-band dipole radiating elements are at different heights.

### CROSS-REFERENCE TO RELATED APPLICATION

The present application claims priority under 35 U.S.C. § 119 to Chinese Patent Application Serial No. 202310445519.X, filed Apr. 24, 2023, the entire content of which is incorporated herein by reference.

### FIELD

The present disclosure relates to communications systems and, in particular, to base station antennas for cellular communications systems.

### BACKGROUND

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station.

Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally. Most modem base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-1 polarized radiating elements, which allows each array to transmit and receive RF signals at two orthogonal polarizations.

Each of the above-described linear arrays is coupled to two ports of a radio (one port for each polarization). An RF signal that is to be transmitted by a linear array is passed from the radio to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Typically these linear arrays will have remote electronic tilt (“RET”) capabilities which allow a cellular operator to change the pointing angle of the generated antenna beams in the elevation (vertical) plane in order to change the size of the sector served by the linear array. Since the antenna beams generated by the above-described 2G/3G/4G linear arrays generate static antenna beams, they are often referred to as “passive” linear arrays.

Most cellular operators are currently upgrading their networks to support fifth generation (“5G”) cellular service. One important component of 5G cellular service is the use of so-called multi-column “active” beamforming arrays that operate in conjunction with beamforming radios to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz and/or the 5.1-5.8 GHz frequency bands. Each column of such an active beamforming array is typically coupled to a respective port of a beamforming radio. The beamforming radio may be a separate device, or may be integrated with the active antenna array. The beamforming radio may adjust the amplitudes and phases of the sub-components of an RF signal that are fed to each port of the radio in order to generate antenna beams that have narrowed beamwidths in the azimuth plane and/or elevation plane (and hence higher antenna gain). These narrowed antenna beams can be electronically steered by proper selection of the amplitudes and phases of the sub-components of an RF signal

In order to avoid having to increase the number of antennas at cell sites, the above-described 5G antennas also often include passive linear arrays that support legacy 2G, 3G and/or 4G cellular services. In some cases, both the active beamforming arrays and the passive linear arrays may be included in a single base station antenna. Another solution for providing an antenna that supports both 2G/3G/4G and 5G cellular service is to mount a 5G active antenna module (i.e., a module that includes an active beamforming array and associated beamforming radio) on the rear surface of a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. This design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

Pursuant to embodiments of the present invention, base station antennas are provided that comprise a first antenna array having a plurality of first frequency band dipole radiating elements and a second antenna array having a plurality of second frequency band dipole radiating elements. A first of the second frequency band dipole radiating elements is mounted on, and forward of, a first of the first frequency band dipole radiating elements.

In some embodiments, the first of the first frequency band dipole radiating elements and the first of the second frequency band dipole radiating elements share a feed stalk. In some embodiments, the shared feed stalk extends through the first of the first frequency band dipole radiating elements to couple to the first of the second frequency band dipole radiating elements. In some embodiments, the shared feed stalk comprises a PCB that includes a first feed line that is coupled to a first dipole of the first of the first frequency band dipole radiating elements and a second feed line that is coupled to a first dipole of the first of the second frequency band dipole radiating elements. In some embodiments, the shared feed stalk is an angled feed stalk, no feed stalk other than the shared feed stalk is coupled to the first of the first frequency band dipole radiating elements, and no feed stalk other than the shared feed stalk is coupled to the first of the second frequency band dipole radiating elements.

In some embodiments, the base station antenna further comprises a metal layer on the feed stalk that extends in parallel to dipole radiators of the first of the first frequency band dipole radiating elements. In some embodiments, the metal layer comprises a frequency selective surface (FSS). In some embodiments, the base station antenna may further comprise a third antenna array having a plurality of third frequency band radiating elements that are mounted rearward of the FSS. In some embodiments, the FSS is a first FSS and the base station antenna further comprises a second FSS that is between the third frequency band radiating elements and the first FSS. In some embodiments, the first frequency band dipole radiating elements are configured to operate in a first frequency band that is lower than a second frequency band in which the second frequency band dipole radiating elements are configured to operate, the second frequency band is lower than a third frequency band in which the third frequency band radiating elements are configured to operate, and the FSS is configured to allow RF energy to pass through at the third frequency band and to reflect RF energy at the second frequency band. In some embodiments, the FSS is configured to not reflect RF energy at the first frequency band. In some embodiments, the second frequency band radiating elements are cloaked with respect to RF energy at the third frequency band.

In some embodiments, the first frequency band dipole radiating elements are configured to operate in a lower frequency band than the second frequency band dipole radiating elements.

In some embodiments, the first frequency band dipole radiating elements are configured to operate in all or part of a 617-960 megahertz frequency band, and the second frequency band dipole radiating elements are configured to operate in all or part of a 1695-2690 megahertz frequency band.

In some embodiments, the base station antenna is a passive base station antenna, and the passive base station antenna is provided as part of a passive/active antenna system that further includes an active antenna module that is on the passive base station antenna.

In some embodiments, the second antenna array is a first of a plurality of antenna arrays of the second frequency band dipole radiating elements, and is mounted farther forward than a second of the plurality of antenna arrays of the second frequency band dipole radiating elements. In some embodiments, the base station antenna is configured to provide phase compensation to compensate for different heights of the second frequency band dipole radiating elements.

In some embodiments, the first of the second frequency band dipole radiating elements is mounted farther forward than a second of the second frequency band dipole radiating elements. In some embodiments, the base station antenna is configured to provide phase compensation to compensate for different heights of the second frequency band dipole radiating elements.

In some embodiments, the first of the first frequency band dipole radiating elements comprises a PCB having an integrated reflector.

Pursuant to further embodiments of the present invention, base station antennas are provided that comprise a first antenna array having a plurality of first frequency band dipole radiating elements and a second antenna array having a plurality of second frequency band dipole radiating elements. A first of the second frequency band dipole radiating elements is fed from the same feed stalk as a first of the first frequency band dipole radiating elements, and the first frequency band dipole radiating elements are configured to operate in a lower frequency band than the second frequency band dipole radiating elements.

In some embodiments, the feed stalk extends through the first of the first frequency band dipole radiating elements to couple to the first of the second frequency band dipole radiating elements.

In some embodiments, the feed stalk comprises a PCB having a first feed line that is coupled to a first dipole of the first of the first frequency band dipole radiating elements; and a second feed line that is coupled to a first dipole of the first of the second frequency band dipole radiating elements.

In some embodiments, the feed stalk is an angled feed stalk.

Pursuant to still further embodiments of the present invention, base station antennas are provided that comprise a first antenna array having a plurality of first frequency band dipole radiating elements and a second antenna array having a plurality of second frequency band dipole radiating elements. A first of the second frequency band dipole radiating elements is completely within a footprint of a first of the first frequency band dipole radiating elements, and the first frequency band dipole radiating elements are configured to operate in a lower frequency band than the second frequency band dipole radiating elements.

In some embodiments, the first of the first frequency band dipole radiating elements comprises a first crossed-dipole radiating element, the first of the second frequency band dipole radiating elements comprises a second crossed-dipole radiating element, a first dipole of the second crossed-dipole radiating element overlaps, in a forward direction, a first dipole of the first crossed-dipole radiating element, and a second dipole of the second crossed-dipole radiating element overlaps, in the forward direction, a second dipole of the first crossed-dipole radiating element.

In some embodiments, the first dipole of the first crossed-dipole radiating element comprises two dipole arms, the first dipole of the second crossed-dipole radiating element comprises two dipole arms that overlap, in the forward direction, the two dipole arms, respectively, of the first dipole of the first crossed-dipole radiating element, the second dipole of the first crossed-dipole radiating element comprises two dipole arms, and the second dipole of the second crossed-dipole radiating element comprises two dipole arms that overlap, in the forward direction, the two dipole arms, respectively, of the second dipole of the first crossed-dipole radiating element.

Pursuant to embodiments of the present invention, passive/active antenna systems are provided that comprise a passive base station antenna and an active antenna module. The passive base station antenna comprises a first antenna array having a plurality of first frequency band dipole radiating elements and a second antenna array having a plurality of second frequency band dipole radiating elements. The active antenna module is mounted behind the passive base station antenna. The first frequency band dipole radiating elements are configured to operate in a lower frequency band than the second frequency band dipole radiating elements, and a first of the second frequency band dipole radiating elements is mounted on, and forward of, a first of the first frequency band dipole radiating elements.

In some embodiments, the active antenna module comprises radio circuitry and a massive MIMO antenna element array.

Pursuant to additional embodiments of the present invention, base station antennas are provided that comprise a reflector, a first antenna array having a plurality of first frequency band dipole radiating elements on the reflector, and a second antenna array having a plurality of second frequency band dipole radiating elements. A first of the second frequency band dipole radiating elements extends farther forward than a second of the second frequency band dipole radiating elements from the reflector, and the first frequency band dipole radiating elements are configured to operate in a lower frequency band than the second frequency band dipole radiating elements.

In some embodiments, the first of the second frequency band dipole radiating elements is mounted on, and forward of, a first of the first frequency band dipole radiating elements, and the second of the second frequency band dipole radiating elements is not mounted on any of the first frequency band dipole radiating elements.

In some embodiments, the base station antenna is configured to provide phase compensation to compensate for different heights of the second-band dipole radiating elements.

Pursuant to other embodiments of the present invention, base station antennas are provided that comprise a reflector, a first antenna array having a plurality of first frequency band dipole radiating elements on the reflector, and second and third antenna arrays that each have a plurality of second frequency band dipole radiating elements. The second frequency band dipole radiating elements of the second antenna array extend farther forward than the second frequency band dipole radiating elements of the third antenna array from the reflector, and the first frequency band dipole radiating elements are configured to operate in a lower frequency band than the second frequency band dipole radiating elements.

In some embodiments, the second frequency band dipole radiating elements of the second antenna array are mounted on, and forward of, the first frequency band dipole radiating elements, respectively, of the first antenna array, and the second frequency band dipole radiating elements of the third antenna array are not mounted on any other dipole radiating elements.

In some embodiments, the base station antenna is configured to provide phase compensation to compensate for different heights of the second frequency band dipole radiating elements.

Pursuant to still other embodiments of the present invention, base station antennas are provided that comprise a first antenna array having a plurality of low-band dipole radiating elements, a metal layer on a rear surface of a first of the low-band dipole radiating elements, a second antenna array having a plurality of mid-band dipole radiating elements, and a third antenna array having a plurality of high-band dipole radiating elements. A first of the mid-band dipole radiating elements is mounted on the first of the low-band dipole radiating elements, the low-band dipole radiating elements are configured to operate in a low frequency band that is lower than a middle frequency band in which the mid-band dipole radiating elements are configured to operate, and the middle frequency band is lower than a high frequency band in which the high-band radiating elements are configured to operate.

In some embodiments, the metal layer comprises an FSS. In some embodiments, the high-band radiating elements are mounted rearward of the FSS. In some embodiments, the FSS is configured to allow RF energy to pass through at the high frequency band and to reflect RF energy at the middle frequency band. In some embodiments, the FSS is configured to not reflect RF energy at the low frequency band. In some embodiments, the mid-band radiating elements are cloaked with respect to RF energy at the high frequency band.

Pursuant to yet additional embodiments of the present invention, base station antennas are provided that comprise a first antenna array having a plurality of first-band dipole radiating elements, wherein a first of the first frequency band dipole radiating elements comprises a printed circuit board (PCB) having an integrated reflector, and a second antenna array having a plurality of second frequency band dipole radiating elements, a first of the second frequency band dipole radiating elements is mounted on the first of the first frequency band dipole radiating elements, and the first frequency band dipole radiating elements are configured to operate in a lower frequency band than the second frequency band dipole radiating elements.

In some embodiments, the integrated reflector comprises an FSS. In some embodiments, the base station antenna further comprises a third antenna array having a plurality of third-band radiating elements that are mounted rearward of the FSS.

In some embodiments, the first frequency band dipole radiating elements are configured to operate in a first frequency band that is lower than a second frequency band in which the second frequency band dipole radiating elements are configured to operate, the second frequency band is lower than a third frequency band in which the third-band radiating elements are configured to operate, and the FSS is configured to allow RF energy to pass through at the third frequency band and to reflect RF energy at the second frequency band.

### BRIEF DESCRIPTION OF THE DRAWINGS

FIG. 1A is a schematic rear perspective view of a passive/active antenna system according to embodiments of the present invention that comprises a passive base station antenna that has an active antenna module mounted thereon.

FIG. 1B is a schematic perspective view of the passive/active antenna system of FIG. 1A with a radome of the passive base station antenna removed.

FIG. 1C is a perspective view of the active antenna module of the passive/active passive/active antenna system of FIGS. 1A-1B.

FIG. 2A is an example schematic front view of low-band arrays included in the passive/active antenna system of FIG. 1A.

FIG. 2B is an example schematic front view of mid-band arrays included in the passive/active antenna system of FIG. 1A.

FIG. 2C is an example schematic front view of high-band arrays included in the passive/active antenna system of FIG. 1A.

FIG. 3A is a schematic block diagram of two radiating elements of FIGS. 2A and 2B that share a feed stalk.

FIG. 3B is a schematic block diagram of a mid-band radiating element of FIG. 2B that is in a footprint of a low-band radiating element of FIG. 2A.

FIG. 4A is a schematic front view of the mid-band radiating element and the low-band radiating element of FIG. 3B.

FIG. 4B is a schematic block diagram in which the low-band radiating element of FIG. 4A has a metal layer on a rear surface thereof.

FIGS. 5A and 5B are opposite schematic side views of a feed stalk that is shared by the mid-band radiating element and the low-band radiating element of FIG. 4A.

FIG. 6A is a front view of a top portion of the passive/active antenna system of FIG. 1B with a second frequency selective surface that is omitted in FIG. 1B in place.

FIG. 6B is a front perspective view of the portion of the passive/active antenna system shown in FIG. 6A.

FIG. 7A is a schematic block diagram illustrating heights of the low-band arrays and mid-band arrays of FIG. 6A.

FIG. 7B is a schematic block diagram illustrating different heights of radiating elements in the same mid-band array, according to other embodiments.

FIG. 7C is a schematic block diagram illustrating phase-compensation circuitry coupled to a mid-band radiating element of FIG. 2B.

### DETAILED DESCRIPTION

Though it may be advantageous to fit low-band, mid-band, and high-band radiating elements in the same base station antenna, arrays of radiating elements that operate in different frequency bands can negatively impact RF performance of each other. Accordingly, to improve performance of a base station antenna, it may be beneficial, for example, to reduce the impact of mid-band radiating elements on the high-band radiating elements. Pursuant to embodiments of the present invention, base station antennas are provided that can reduce the impact of mid-band radiating elements on high-band radiating elements by integrating mid-band radiating elements with low-band radiating elements. As an example, a mid-band radiating element can be mounted on, and forward of, a low-band radiating element. For a base station antenna system that includes both a passive base station antenna having low-band and mid-band linear arrays and an active antenna module having one or more multi-column arrays of high-band radiating elements, integrated radiating elements can reduce the extent to which the radiating elements of the passive base station antenna shield the high-band radiating elements of the active antenna module (e.g., by using less metal), and can thereby improve the performance of the active antenna module. Moreover, even if a passive base station antenna does not include an associated active antenna module, integrated radiating elements can reduce the extent to which the low-band arrays shield the radiating elements of the mid-band arrays, and can thereby improve the performance of the mid-band arrays.

In some embodiments, a mid-band radiating element and a low-band radiating element that are integrated with each other and can share the same feed stalk. By sharing a single feed stalk between two radiating elements, costs can be reduced. According to some embodiments, the shared feed stalk may be the only feed stalk for either radiating element. A cross-stalk (i.e., a feed stalk that comprises two feed stalk printed circuit boards that are mated together so the the two printed circuit boards intersect at a 90° angle) is thus not necessary for either radiating element. Eliminating cross-stalks can reduce unwanted shielding/reflection, and can also further reduce cost.

Example embodiments of the present invention will be described in greater detail with reference to the attached figures.

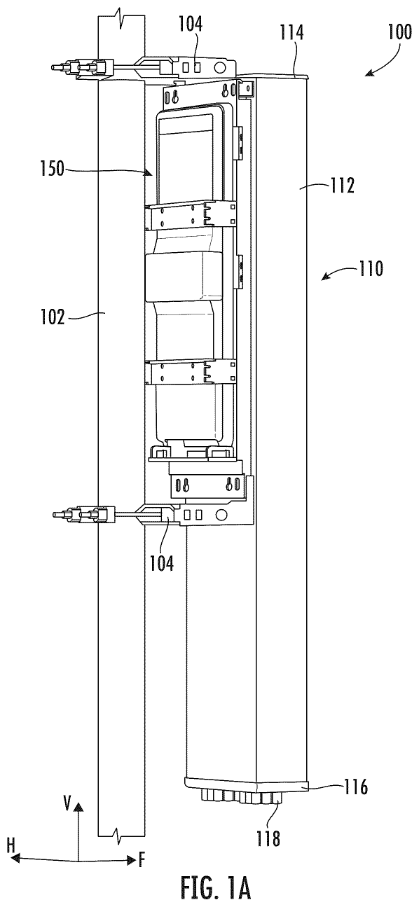

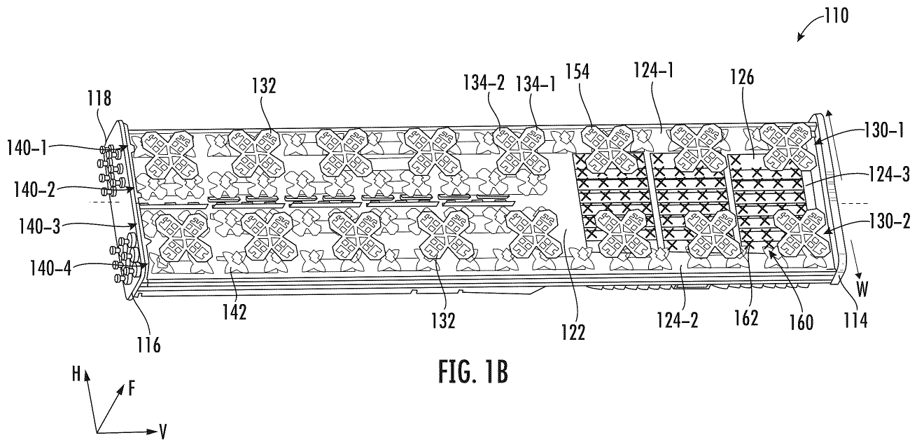

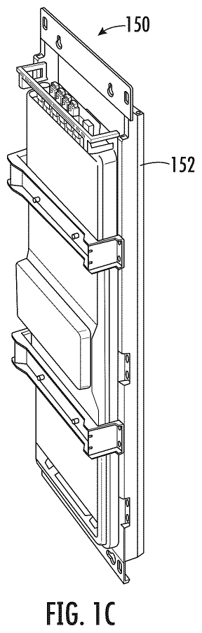

FIGS. 1A-1C illustrate a passive/active antenna system 100 that includes both a passive base station antenna and an active antenna module. In particular, FIG. 1A is a schematic rear perspective view of a passive/active antenna system 100. FIG. 1B is a schematic perspective view of the passive/active antenna system 100 of FIG. 1A with a radome of the passive base station antenna omitted. FIG. 1C is a perspective view of the active antenna module shown in FIG. 1A. In FIGS. 1A and 1B, the axes illustrate the vertical (V), horizontal (H) and forward (F) directions of the base station antenna system 100.

Referring to FIG. 1A, the passive/active antenna system 100 may be mounted, for example, on an antenna tower 102 using mounting hardware 104. The passive/active antenna system 100 includes a passive base station antenna 110 and an active antenna module 150 that is mounted behind the passive base station antenna 110. The active antenna module 150 may be mounted directly on a rear surface of the passive base station antenna 110, or may be held in place behind the passive base station antenna 110 by, for example, the mounting hardware 104 that is used to mount the passive/active antenna system 100 on the antenna tower 102 (or other structure). The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module, preferably without removing the passive base station antenna 110 from the antenna tower 102.

Referring to FIG. 1B, the passive base station antenna 110 includes a reflector assembly 120 and a plurality of passive linear arrays of radiating elements that extend forwardly from the passive reflector assembly 120. The reflector assembly 120 may be referred to herein as a “passive reflector assembly” since it is part of the passive base station antenna 110. The linear arrays may support, for example, 3G and/or 4G cellular service. In the example passive base station antenna 110 shown in FIGS. 1A-1B, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell.

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in the array, and the second RF port 118 is connected between a second port of a radio and the second polarization radiators of the radiating elements in the array. RF signals that are to be transmitted by a selected one of the linear arrays 130, 140 are passed from the radio to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components are radiated into free space.

The passive reflector assembly 120 includes a main reflector 122 and spaced-apart first and second reflector strips 124-1, 124-2 that extend vertically from respective first and second opposed sides of the main reflector 122. The passive reflector assembly 120 may further include a third reflector strip 124-3 that extends in the horizontal direction between the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. Most of the low-band and mid-band radiating elements 132, 142 are mounted to extend forwardly from the main reflector 122. However, low-band linear arrays 130-1, 130-2 and mid-band linear arrays 140-2, 140-3 each extend substantially the full length of the passive/active antenna system 100 and hence extend beyond the main reflector 122. The first and second reflector strips 124-1, 124-2 provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may be important for the performance of the linear arrays 130-1, 130-2, 140-2, 140-3.

Each low-band radiating element 132 may comprise a slant −45°/+45° cross-dipole radiating element that includes a −45° dipole radiator 134-1 and a +45° dipole radiator 134-2 that are arranged to form a cross when the radiating element 132 is viewed from the front. The dipole radiators 134 may (but need not) extend in a plane that is parallel to a plane defined by the main reflector 122. The dipole radiators 134-1, 134-2 may be mounted on a feed stalk 136 of the radiating element 132. Conventionally, cross-dipole radiating elements extend forwardly from a main reflector surface of a reflector assembly with the feed stalks the radiating elements extending perpendicularly to the main reflector surface. The feed stalk may be configured to pass RF signals between the dipole radiators and an associated feed network, and may also be used to support the dipole radiators forwardly of the reflector assembly. The radiating elements 132 that extend forwardly from the main reflector 122 may have a conventional design where the feed stalks extend perpendicularly to the main reflector 122. However, the centers of the low-band radiating elements 132 that are mounted on the first and second reflector strips 124-1, 124-2 are above the opening 126, and hence conventional radiating elements cannot be readily used. Thus, the three uppermost low-band radiating elements 132 have so-called “tilted” feed stalks 136 that extend forwardly from the reflector strips 124-1, 124-2 at oblique angles. In particular, the base of each feed stalk 136 is mounted on one of the reflector strips 124-1, 124-2, and the feed stalk 136 extends at an angle so that the center of the cross defined by the dipole radiators 134-1, 134-2 is above the opening 126. In example embodiments, the feed stalks 136 may extend at an angle of about 30°-60° with respect to the front surface of the reflector strips 124-1, 124-2. In addition, the three uppermost low-band radiating elements 132 have also each include a respective integrated mid-band radiating element 142 mounted thereon, as will be discussed in further detail below.

Referring to FIGS. 1B and 1C, the active antenna module 150 includes a multi-column beamforming array 160 of radiating elements 162 and a beamforming radio (not visible in the figures). The multi-column beamforming array 160 may be mounted in a forward portion of a radome 152 of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band. The high-band radiating elements 162 are mounted to extend forwardly from a reflector 154 of the active antenna module 150 (herein the “active reflector”). The beamforming radio is capable of electronically adjusting the amplitudes and/or phases of the subcomponents of an RF signal that are output to different radiating elements 162 of the multi-column beamforming array 160. For example, each port of the beamforming radio may be coupled to a column of radiators of the beamforming array 160, and the amplitudes and phases of the sub-components of the RF signal that are fed to the radiators in each column may be adjusted so that the generated antenna beam is narrowed in the azimuth plane and pointed in a desired direction in the azimuth plane. The active antenna module 150 may further include other components such as filters, a calibration network, an antenna interface signal group (AISG) controller and the like.

As is shown in FIG. 1B, the beamforming array 160 of active antenna module 150 is mounted behind the opening 126 in the passive reflector assembly 114. The beamforming array 160 is visible in FIG. 1B as the radomes 112, 152 of both the passive base station antenna 110 and the active antenna module 150 are removed in the view of FIG. 1B. The opening 126 in the passive reflector assembly 120 allows the antenna beams generated by the beamforming array 160 to pass through the passive base station antenna 110 and out of the front of the radome 112 of the passive base station antenna 110 to provide service to the coverage area of the passive/active antenna system 100. The opening 126 may be covered by a frequency selective surface, as will be discussed in greater detail below.

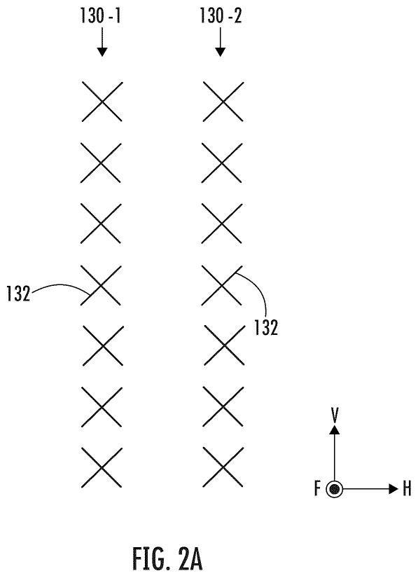

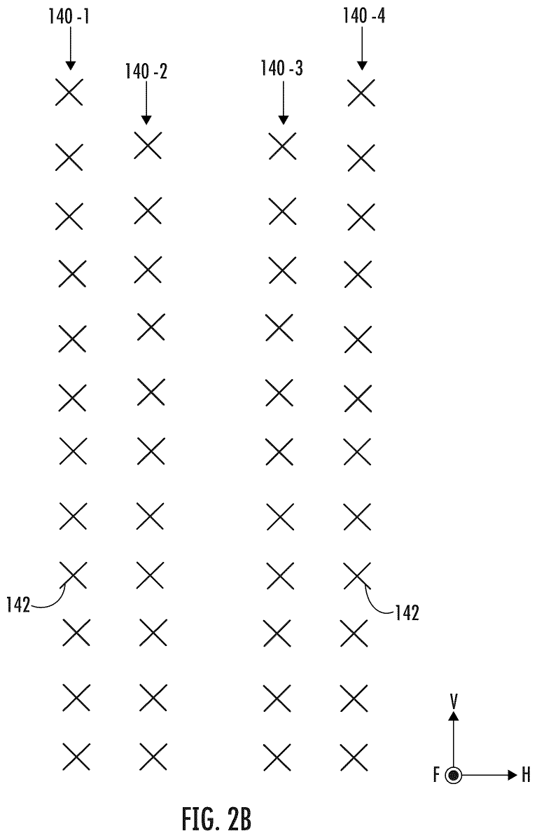

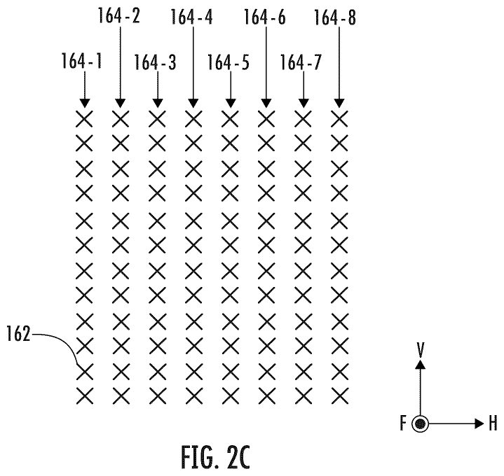

FIG. 2A is an example schematic front view of the two low-band arrays 130-1, 130-2 that are included in the passive/active antenna system 100 of FIGS. 1A-1C. The two low-band arrays 130-1, 130-2 are spaced apart from each other in a horizontal direction H. Each low band 130 array includes a plurality of low-band radiating elements 132 and may extend in a vertical direction V from a lower portion of the passive/active antenna system 100 to an upper portion thereof. Each low-band array 130 may thus be referred to as a “vertical column.” The vertical direction V may be, or may be parallel with, a longitudinal axis of the passive base station antenna. The vertical direction V may also be perpendicular to the horizontal direction H and a forward direction F. As used herein, the term “vertical” does not necessarily require that something is exactly vertical (e.g., the passive/active antenna system 100 may have a small mechanical down-tilt).

The low-band arrays 130 are each configured to transmit and/or receive RF signals in one or more frequency bands, such as all or part of the 617-960 MHz frequency band. Though FIG. 2A illustrates two arrays 130-1, 130-2, the passive base station antenna 110 may include more or fewer low-band arrays 130. Moreover, the number of radiating elements 132 included in each low-band array 130 can be any quantity from two to twenty or more, with five to nine radiating elements being most typical.

FIG. 2B is an example schematic front view of the four mid-band arrays 140-1 to 140-4 that are included in the passive base station antenna 110 of FIG. 1A. The four mid-band arrays 140-1 to 140-4 are spaced apart from each other in the horizontal direction H. Each mid-band array 140 (e.g., vertical column) includes a plurality of mid-band radiating elements 142 and may extend in the vertical direction V.

The mid-band arrays 140 are each configured to transmit and/or receive RF signals in one or more frequency bands, such as in all or a portion of the 1427-2690 MHz frequency band. Though FIG. 2B illustrates four mid-band arrays 140-1 to 140-4, the passive base station antenna 110 may include more (e.g., five or more) or fewer (e.g., two or three) mid-band arrays 140. Moreover, the number of radiating elements 142 in each mid-band array 140 can be any quantity from two to twenty or more.

FIG. 2C is an example schematic front view of a multi-column array 160 of high-band radiating elements 162 that is included in the active antenna module 150 of FIGS. 1A-1C. The high-band array 160 include four columns 164-1 through 164-8 of high-band radiating elements 162. The four columns 164 are spaced apart from each other in the horizontal direction H. Each column 164 may extend in the vertical direction V from a lower portion of the active antenna module 150 to an upper portion thereof.

The high-band array 160 is configured to transmit and/or receive RF signals in one or more frequency bands, such as one or more bands comprising 3.1-4.2 GHz (e.g., 3.3-4.2 GHz). Though FIG. 2C illustrates an eight column high-band array 160, the high-band array 160 may include more or fewer columns 164 of radiating elements 162. Moreover, the number of radiating elements 162 in each column 164 can be any quantity from two to twenty or more.

For simplicity of illustration, the low-band arrays 130 (FIG. 2A) and the mid-band arrays 140 (FIG. 2B) are omitted from view in FIG. 2C. Likewise, the high-band array 160 is omitted from view in FIGS. 2A and 2B, and the low-band and mid-band arrays 130, 140 are omitted from view in FIGS. 2B and 2A, respectively.

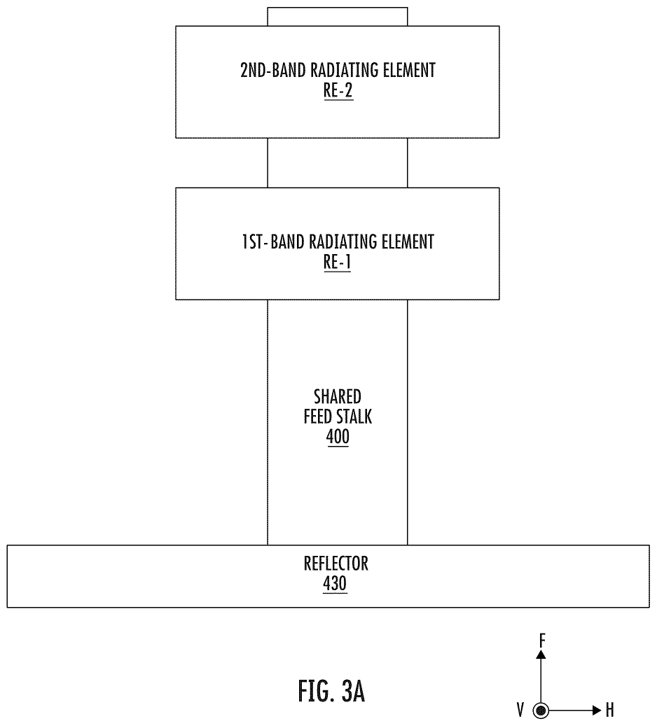

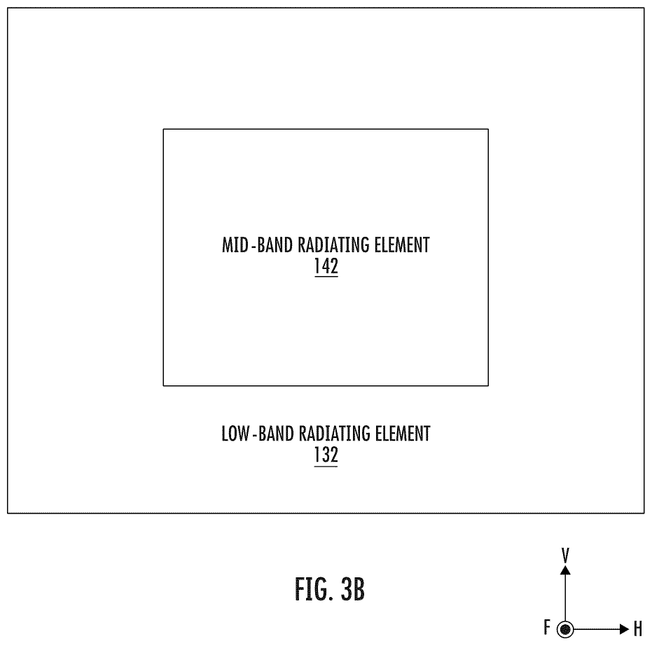

FIG. 3A is a schematic block diagram of first and second radiating elements RE-1, RE-2 (e.g., a low-band radiating element 132 and a mid-band radiating element 142 of FIGS. 2A and 2B) that share a feed stalk 400. As shown in FIG. 3A, the first-band radiating element RE-1 and the second-band radiating element RE-2 may be mounted on the shared feed stalk 400 at different distances, respectively, forward (in the forward direction F) of a reflector 430. The shared feed stalk 400 may, for example, be mounted on the reflector 430 or mounted on a feed board printed circuit board (not shown) that is mounted on the reflector 430. The shared feed stalk 400 extends forwardly from the reflector 430. As a result, the second-band radiating element RE-2 overlaps the first-band radiating element RE-1 in the forward direction F (i.e., an axis that is perpendicular to the reflector 430 extends through both the first-band radiating element RE-1 and the second-band radiating element RE-2). As an example, the first-band radiating element RE-1 and the second-band radiating element RE-2 may be respective dipole radiating elements (e.g., respective crossed-dipole radiating elements), and at least one dipole of the second-band radiating element RE-2 may overlap a respective dipole of the first-band radiating element RE-1 in the forward direction F.

The shared feed stalk 400 is coupled to both the first-band radiating element RE-1 and the second-band radiating element RE-2. For example, the shared feed stalk 400 may extend through the first-band radiating element RE-1 to couple to the second-band radiating element RE-2. In some embodiments, the shared feed stalk 400 may be the only feed stalk that is coupled to the first-band radiating element RE-1 and the only feed stalk that is coupled to the second-band radiating element RE-2. Accordingly, the first-band radiating element RE-1 and the second-band radiating element RE-2 may not be coupled to any other feed stalk. The first-band radiating element RE-1 and the second-band radiating element RE-2 thus may not be fed by a cross-stalk, unlike conventional radiating elements (e.g., conventional mid-band radiating elements).

According to some embodiments, the first-band radiating element RE-1 and the second-band radiating element RE-2 may be a low-band radiating element 132 (FIG. 2A) and a mid-band radiating element 142 (FIG. 2B), respectively. The mid-band radiating element 142 may thus be mounted on, and forward (in the forward direction F) of, the low-band radiating element 132. In other embodiments, the first-band radiating element RE-1 and the second-band radiating element RE-2 may be a mid-band radiating element 142 and a low-band radiating element 132, respectively, such that the low-band radiating element 132 is mounted on, and forward of, the mid-band radiating element 142. Accordingly, the mid-band radiating element 142 may be between, in the forward direction F, the reflector 430 and the low-band radiating element 132, or the low-band radiating element 132 may be between, in the forward direction F, the reflector 430 and the mid-band radiating element 142. Other embodiments are possible. For example, the second-band radiating element RE-2 may be a high-band radiating element 162 and the first-band radiating element RE-1 may be a low-band radiating element 132 or a mid-band radiating element 142.

FIG. 3B is a schematic block diagram of a mid-band radiating element 142 of FIG. 2B that is in a footprint of a low-band radiating element 132 of FIG. 2A. As shown in FIG. 3B, the mid-band radiating element 142 does not extend outward beyond the footprint of the low-band radiating element 132 in either the horizontal direction H or the vertical direction V. Accordingly, an entirety of the mid-band radiating element 142 may be within the footprint of the low-band radiating element 132.

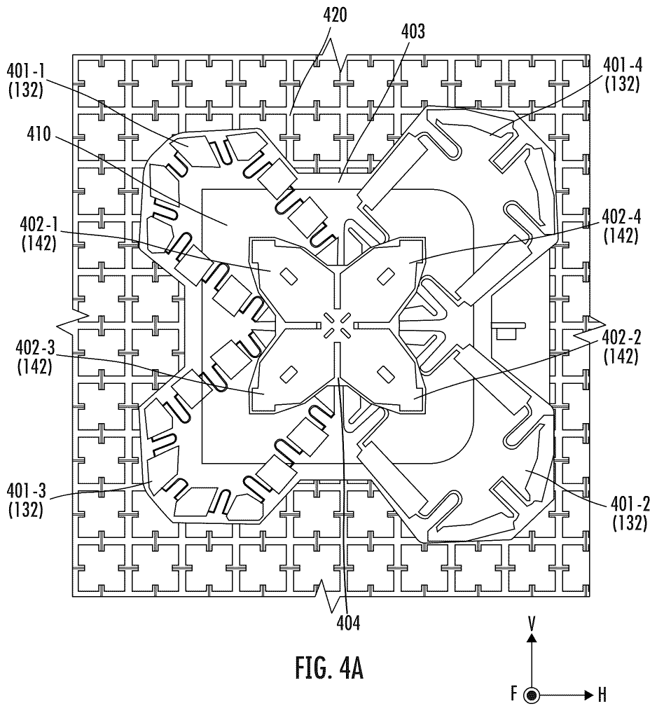

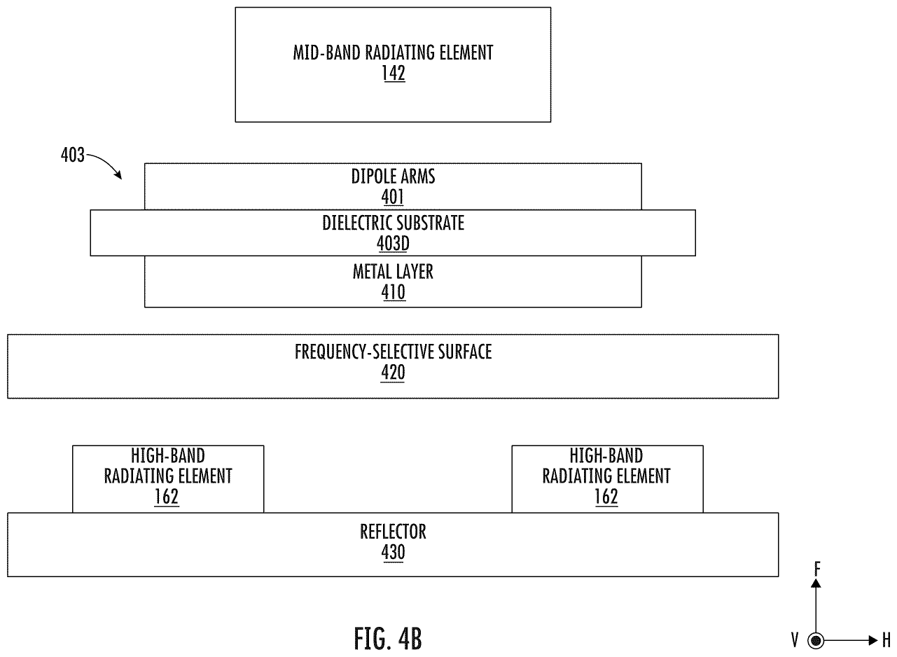

FIG. 4A is a schematic front view of the mid-band radiating element 142 and the low-band radiating element 132 of FIG. 3B. As shown in FIG. 4A, the mid-band radiating element 142 and the low-band radiating element 132 may be respective crossed-dipole radiating elements. The low-band radiating element 132 may comprise a first dipole having first and second dipole arms 401-1, 401-2 and a second dipole having third and fourth dipole arms 401-3, 401-4. The mid-band radiating element 142 may comprise a first dipole having first and second dipole arms 402-1, 402-2 and a second dipole having third and fourth dipole arms 402-3, 402-4. The first through fourth dipole arms 401-1 to 401-4 of the low-band radiating element 132 may share (i.e., may each be on) a front surface of a PCB 403 of the low-band radiating element 132, and the first through fourth dipole arms 402-1 to 402-4 of the mid-band radiating element 142 may share a front surface of a PCB 404 of the mid-band radiating element 142 in example embodiments.

The low-band radiating element 132 and the mid-band radiating element 142 may each be dual-polarized (e.g., slant −/+45° crossed-dipole radiating elements). As an example, the first dipoles of the low-band radiating element 132 and the mid-band radiating element 142 may be first-polarization radiators, and the second dipoles of the low-band radiating element 132 and the mid-band radiating element 142 may be second-polarization radiators, where the second polarization (e.g., −45°) is different from (e.g., orthogonal to) the first polarization (+45°).

In some embodiments, each dipole of the mid-band radiating element 142 may overlap, in the forward direction F, a respective dipole of the low-band radiating element 132. For example, each dipole arm 402 of the mid-band radiating element 142 may overlap, in the forward direction F, a respective dipole arm 401 of the low-band radiating element 132.

Accordingly, the first through fourth dipole arms 402-1 to 402-4 of the mid-band radiating element 142 may overlap, in the forward direction F, the first through fourth dipole arms 401-1 to 401-4, respectively, of the low-band radiating element 132. As an example, the first through fourth mid-band dipole arms 402-1 to 402-4 may be forward of the first through fourth low-band dipole arms 401-1 to 401-4, respectively, by a distance of about a quarter-wavelength corresponding to a center frequency of the operating frequency band of the mid-band radiating element 142.

According to some embodiments, the low-band radiating element 132 may have a metal layer 410 on a rear surface thereof, such as on a rear surface 403R (FIG. 4B) of the PCB 403. The metal layer 410 may be, for example, a generally square shaped metal sheet and may serve as a reflector for the mid-band radiating element 142. The metal layer 410 may be referred to herein as an “integrated reflector,” as it may be integrated with/part of the PCB 403 of the low-band radiating element 132 and reflects RF energy at an operating frequency band (a “middle frequency band”) of the mid-band radiating elements 142.

Moreover, the metal layer 410 may be ungrounded, and thus may be electrically floating in some embodiments (but can also be grounded). For simplicity of illustrating a shape and position of the metal layer 410 relative to shapes and positions of the dipole arms 401, 402, FIG. 4A depicts the metal layer 410 as being visible from a front side of the PCB 403. In some embodiments, however, the metal layer 410 may not be visible from the front side of the PCB 403. For example, the PCB 403 may be opaque rather than translucent.

In some embodiments, instead of being a continuous metal sheet, the metal layer 410 may be a frequency selective surface (“FSS”), which may act as a spatial filter that passes, or substantially attenuates, and/or reflects RF energy, depending on the frequency of the RF energy. FSSs are known in the art, and typically comprise a grid pattern of unit cells such as a grid pattern of metal patches and/or other metal structures that form resonant circuits. The metal patches/structures may be arranged in one or more layers. The FSS may be implemented, for example, as a piece of sheet metal with the grid structure punched or otherwise formed therein or as a dielectric substrate with one or more metal patterns formed therein (such a printed circuit board). An FSS may be configured to substantially pass RF energy that is incident thereon in a first frequency range while partially or substantially attenuating (e.g., reflecting) RF energy that is incident thereon in a second frequency range. As an example, the metal layer 410 may be configured to allow RF energy to pass through at a high frequency band (at which high-band radiating elements 162 of FIG. 2C operate) and to reflect RF energy at the middle frequency band (at which mid-band radiating elements 142 operate). Moreover, the metal layer 410 may be configured to reflect RF energy at only one frequency band (e.g., the middle frequency band), and thus may be configured to pass (i.e., not reflect or absorb) RF energy at a low frequency band (at which low-band radiating elements 132 operate). The middle frequency band is lower than the high frequency band and higher than the low frequency band. Examples of FSSs (including spatial-filtering properties thereof) are discussed in U.S. Pat. No. 11,482,774 to Hou et al., the entire content of which is incorporated herein by reference.

The passive/active antenna system 100 may also include a second FSS 420 that is mounted rearward of the metal layer 410. The second FSS 420 may, in some embodiments, be configured to allow RF energy to pass through at the high frequency band and to reflect RF energy at the low frequency band. Moreover, the second FSS 420 may be configured to not reflect RF energy at the middle frequency band, as the second FSS 420 may be reflective for only a single frequency band (e.g., the low frequency band) rather than multiple frequency bands. The second FSS 420 is longer, in both the vertical direction V and the horizontal direction H, than the metal layer 410, which may thus be in a footprint of the second FSS 420. According to some embodiments, the metal layer 410 and the second FSS 420 may be first and second FSSs, respectively. High-band radiating elements 162 may be mounted rearward of the second FSS 420, as will be described herein with respect to FIG. 4B and as is also described in greater detail in U.S. Pat. No. 11,482,774 to Hou et al.

FIG. 4A also shows that an entirety of each dipole arm 402 of the mid-band radiating element 142 may be in a footprint of the low-band radiating element 132. For example, an entirety of the mid-band radiating element 142 may be in a footprint of (i.e., may overlap, in the forward direction F) the PCB 403 of the low-band radiating element 132. In some embodiments, an entirety of the mid-band radiating element 142 may be in a footprint of the metal layer 410 that is on a rear surface of the low-band radiating element 132.

According to some embodiments, the mid-band radiating elements 142 may be cloaked with respect to RF energy at the high frequency band. Dipole radiators of each cloaked mid-band radiating element 142 may be substantially transparent to RF energy in the high frequency band. The mid-band radiating elements 142 may thus be “cloaking” radiating elements that have reduced impact on antenna beams generated by closely-located radiating elements that transmit and receive signals in other frequency bands (i.e., reduced scattering). Example cloaking radiating elements are discussed in U.S. Patent App. No. 63/431,426 to Wu et al., the disclosure of which is hereby incorporated herein by reference in its entirety.

In some embodiments, directors may be on the mid-band radiating elements 142. For example, directors may be mounted forwardly of the dipoles of the mid-band radiating elements 142 (e.g., using a plastic support structure that is mounted on PCB 404 or may be mounted on an interior surface of the radome 112 (FIG. 1A) that faces the mid-band radiating elements 142). The directors may be metal structures that act as parasitic radiating elements that receive and re-radiate radio waves from driven radiating elements (here the dipoles of the respective mid-band radiating elements 142) but in a different phase. The effect of the directors is to enhance radiation in a given direction, thereby increasing the gain of the “element antenna beam” generated by the radiating element that includes the director in that direction. For simplicity of illustration, directors are not shown in FIG. 4A.

Various techniques can be used to provide the directors on the interior surface of the radome 112. For example, the directors can be on a thin PCB that is adhered (e.g., with double-sided tape) to the interior surface of the radome 112. As another example, the directors may be printed onto the interior surface of the radome 112. In a further example, the directors can be implemented as sheet metal that is suspended from the interior surface of the radome 112. Moreover, the directors may be mounted on the interior surface of the radome 112 by using pick-and-place equipment, examples of which are discussed in U.S. Pat. No. 10,741,920, the entire content of which is incorporated herein by reference.

FIG. 4B is a schematic block diagram in which the low-band radiating element 132 of FIG. 4A. The low-band radiating element 132 is implemented using a PCB 403 that includes a dielectric substrate 403D with a front metallization layer and a back metallization layer formed on the two major surfaces of the dielectric substrate 403D. The dipole arms 401-1 through 401-4 are implemented in the front metallization layer. The rear metallization layer may comprise a metal layer 410 which may be a continuous or patterned metal layer. The metal layer 410 may face a front (e.g., forwardmost) surface of the second FSS 420. A plurality of high-band radiating elements 162 may be mounted (e.g., on the reflector 430) rearward of the metal layer 410 and rearward of the second FSS 420. The second FSS 420 may be between, in the forward direction F, the high-band radiating elements 162 and the metal layer 410. For simplicity of illustration, the shared feed stalk 400 (FIG. 3A) that feeds both the low-band radiating element 132 and the mid-band radiating element 142 is omitted from view in the FIG. 4B.

While FIG. 4B shows the dipole arms 401-1 through 401-4 being implemented in the front metallization layer and the metal layer 410 being implemented in the rear metallization layer, in some embodiments (e.g., embodiments where the metal layer 410 is implemented as an FSS) these elements may be reversed so that the metal layer 410 is forward of the dipole arms 401-1 through 401-4. It will also be appreciated that the metal layer 410 may be separate from the PCB 403 (e.g., a sheet metal layer of another PCB) and that the dipole arms 401 need not be implemented using a PCB in other embodiments.

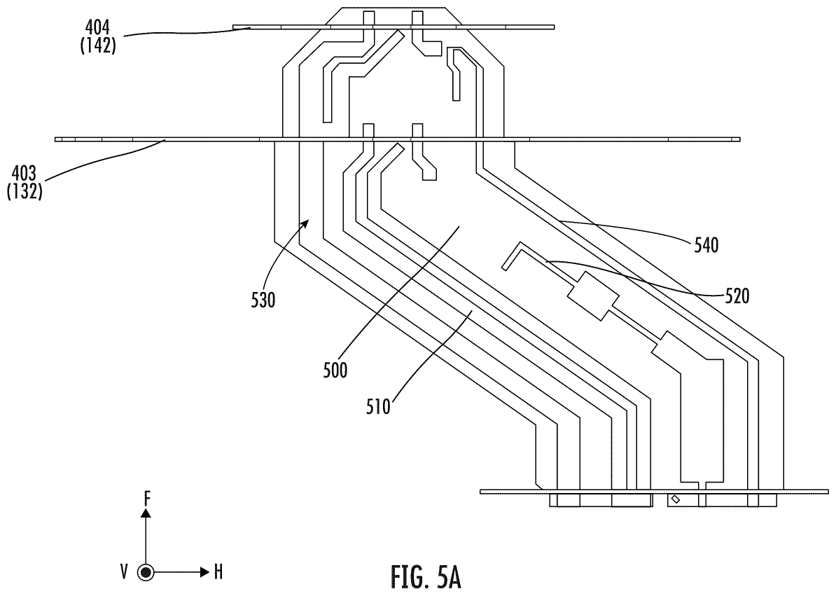

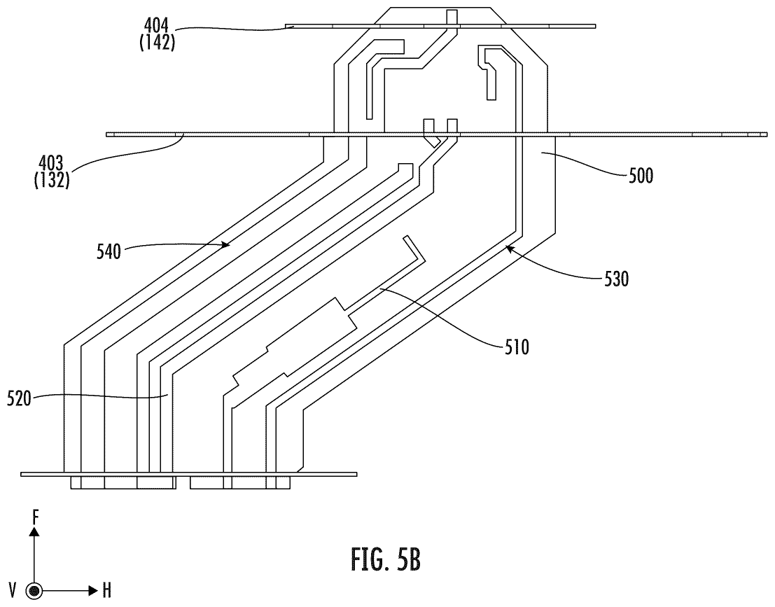

FIGS. 5A and 5B are opposite schematic side views of a feed stalk 500 that is shared by the mid-band radiating element 142 and the low-band radiating element 132 of FIG. 4A. The shared feed stalk 500 is an example of the shared feed stalk 400 that is shown in FIG. 3A. As shown in FIGS. 5A and 5B, the shared feed stalk 500 is a PCB feed stalk having a first feed line 510 that is coupled to a first dipole (having first and second dipole arms 401-1, 401-2 (FIG. 4A)) of the low-band radiating element 132 via the PCB 403 of the low-band radiating element 132.

The PCB feed stalk 500 also has a second feed line 530 that is coupled to a first dipole (having first and second dipole arms 402-1, 402-2 (FIG. 4A)) of the mid-band radiating element 142 via the PCB 404 of the mid-band radiating element 142, a third feed line 520 that is coupled to a second dipole (having third and fourth dipole arms 401-3, 401-4 (FIG. 4A)) of the low-band radiating element 132 via the PCB 403, and a fourth feed line 540 that is coupled to a second dipole (having third and fourth dipole arms 402-3, 402-4 (FIG. 4A)) of the mid-band radiating element 142 via the PCB 404. The first through fourth feed lines 510-540 may comprise conductive (e.g., copper or other metal) traces on the PCB feed stalk 500.

FIGS. 5A and 5B show that the PCB feed stalk 500 extends through the PCB 403 (e.g., through a slot in PCB 403) to couple to the PCB 404. In some embodiments, the PCB feed stalk 500 is not a cross-stalk and is the only feed stalk that is coupled to either the PCB 403 or the PCB 404. Moreover, the PCB feed stalk 500 may be an angled (e.g., tilted) feed stalk, as shown by the angled middle portion (rearward of the PCB 403) of the PCB feed stalk 500 in FIGS. 5A and 5B, rather than a straight feed stalk.

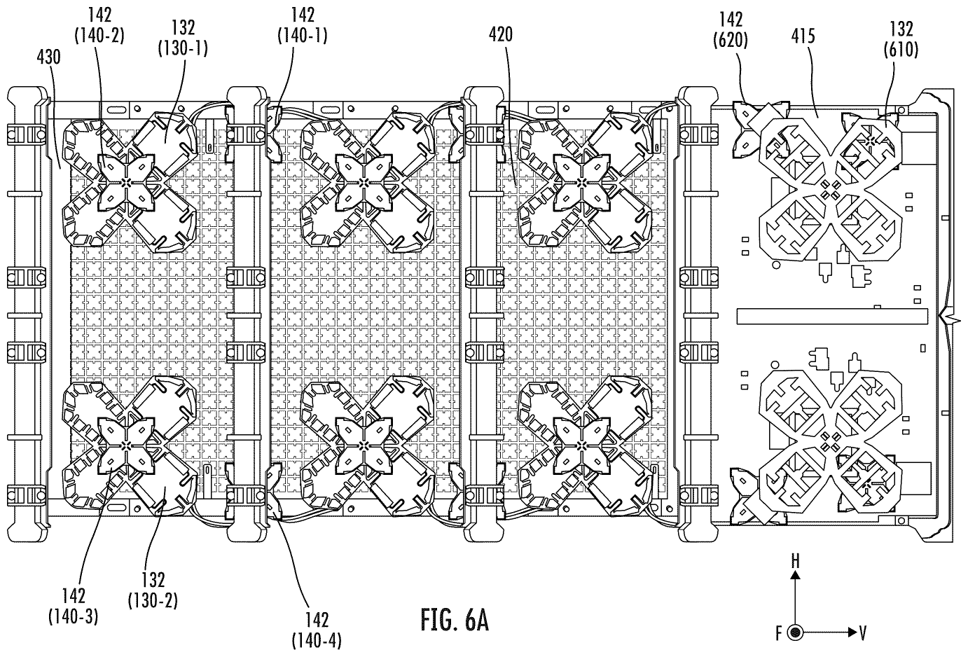

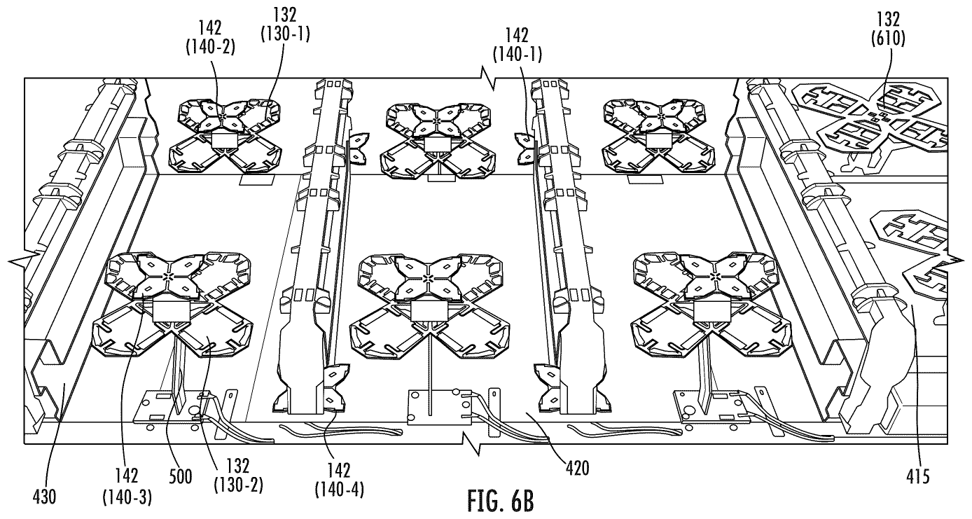

FIG. 6A is a front view of portions of the low-band arrays 130 of FIG. 2A and two of the mid-band arrays 140 of FIG. 2B. In some embodiments, the low-band arrays 130 and the mid-band arrays 140 may be part of the passive base station antenna 110 (FIG. 1A) of an passive/active antenna system 100. Accordingly, the view that is shown in FIG. 6A may be a view of the passive base station antenna 110 having its radome 112 (FIG. 1A) removed (for convenience of illustration). Moreover, the passive/active antenna system 100 may include at least one active antenna module 150 (FIG. 1B) that is on (e.g., attached to) the passive base station antenna 110.

As shown in FIG. 6A, the second and third arrays 140-2, 140-3 of mid-band radiating elements 142 may be mounted on, and forward of (in the forward direction F), the first and second arrays 130-1, 130-2, respectively, of low-band radiating elements 132. For example, FIG. 6A shows six mid-band radiating elements 142 that are integrated with six low-band radiating elements 132, respectively. The integrated radiating elements are on or extend over the second FSS 420, which is forward of the reflector 430.

In some embodiments, the passive base station antenna 110 may include low-band radiating elements 132 and/or mid-band radiating elements 142 that are not on (or overlapping) the second FSS 420. As an example, FIG. 6A shows two low-band radiating elements 610 and two mid-band radiating elements 620 that are on a reflector 415 (which corresponds to the main reflector 122 in FIG. 1B) and do not overlap (in the forward direction F) the second FSS 420. According to some embodiments, the reflector 415 may be at a different level, in the forward direction F, than the reflector 430. For example, the reflector 415 may be elevated forward of a level of the reflector 430 (and forward of a level of the second FSS 420), such that the low-band radiating elements 610 may extend farther forward (in the forward direction F) than the low-band radiating elements 132 that are on the second FSS 420. Moreover, due to space limitations in the forward direction F for the low-band radiating elements 610, the mid-band radiating elements 620 may not be mounted on the low-band radiating elements 610.

FIG. 6A also shows that the second and third arrays 140-2, 140-3 of mid-band radiating elements 142 may be located inward, in the horizontal direction H, of the first and fourth arrays 140-1, 140-4 of mid-band radiating elements 142. In other embodiments, the second and third mid-band arrays 140-2, 140-3 may be located outward, in the horizontal direction H, of the first and fourth mid-band arrays 140-1, 140-4. Moreover, each mid-band radiating element 142 in the first array 140-1 may be adjacent and equidistant from (and thus overlapping with), in the vertical direction V, two low-band radiating elements 132 in the first array 130-1. Similarly, each mid-band radiating element 142 in the fourth array 140-4 may be adjacent and equidistant from (and thus overlapping with), in the vertical direction V, two low-band radiating elements 132 in the second array 130-2.

FIG. 6B is a front perspective view of the low-band arrays 130 and the mid-band arrays 140 that are shown in FIG. 6A. As shown in FIG. 6B, each low-band radiating element 132 that is on the second FSS 420 may be fed by a respective shared feed stalk 500 that also feeds a respective mid-band radiating element 142 that is mounted on, and forward of, the low-band radiating element 132. The shared feed stalk 500 may be angled inward toward the center of (and thus away, in the horizontal direction H (FIG. 6A), from an outer edge of) the reflector 430. Mid-band radiating elements 142 of the second and third arrays 140-2, 140-3 that are fed by shared feed stalks 500 extend farther forward than mid-band radiating elements 142 of the first and fourth arrays 140-1, 140-4 that do not share feed stalks with low-band radiating elements 132. Moreover, FIG. 6B shows the elevated reflector 415 and the low-band radiating elements 610 thereon that extend farther forward than the low-band radiating elements 132 that are on the second FSS 420.

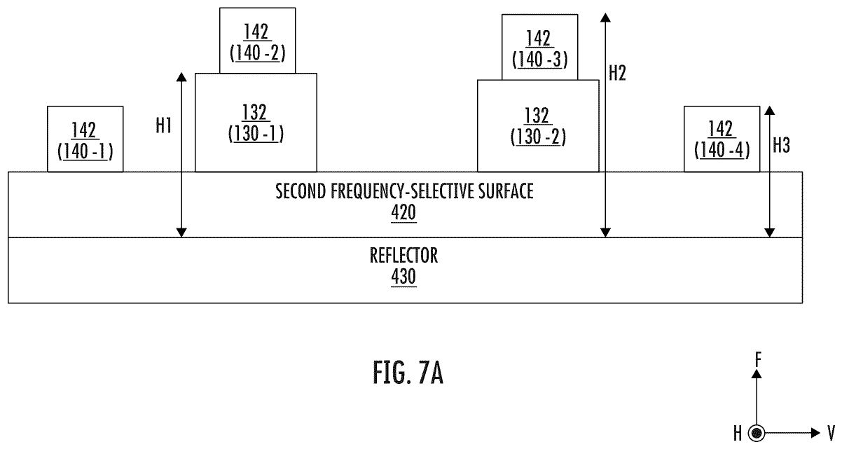

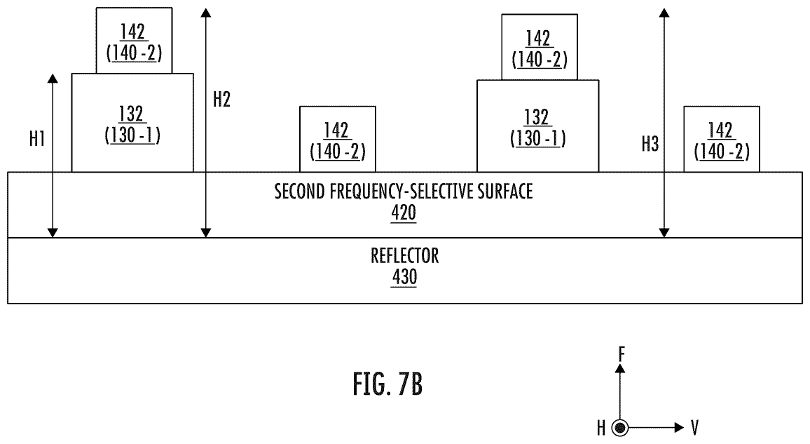

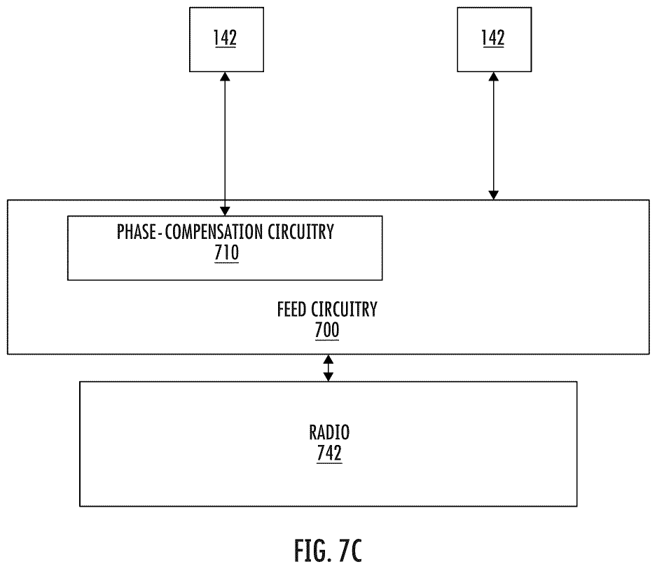

FIG. 7A is a schematic block diagram illustrating heights of the low-band arrays 130 and mid-band arrays 140 of FIG. 6A. As shown in FIG. 7A, the second and third mid-band arrays 140-2, 140-3 (which are mounted on, and forward of, the first and second low-band arrays 130-1, 130-2) extend farther forward than the first and fourth mid-band arrays 140-1, 140-4. For example, the second and third mid-band arrays 140-2, 140-3 may have a second height H2 (in the forward direction F) from the reflector 430 that is higher/longer than a third height H3 (in the forward direction F) of the first and fourth mid-band arrays 140-1, 140-4 from the reflector 430. A first height HI (in the forward direction F) of the first and second low-band arrays 130-1, 130-2 from the reflector 430 may be higher/longer than the third height H3 and lower/shorter than the second height H2.

For simplicity of illustration, the first and fourth mid-band arrays 140-1, 140-4 are shown in FIG. 7A as horizontally overlapping the first and second low-band arrays 130-22 1, 130-2. As shown in FIG. 6A, however, the first and fourth mid-band arrays 140-1, 140-4 may not overlap the first and second low-band arrays 130-1, 130-2 in the horizontal direction H. Rather, the first and fourth mid-band arrays 140-1, 140-4 may overlap the first and second low-band arrays 130-1, 130-2, respectively, in the vertical direction V.

FIG. 7B is a schematic block diagram illustrating different heights of radiating elements 142 in the same (second) mid-band array 140-2, according to other embodiments. As shown in FIG. 7B, two radiating elements RE-M of the second mid-band array 140-2 that are mounted on respective low-band radiating elements 132 have the second height H2, while two radiating elements 142 of the second mid-band array 140-2 that are not mounted on low-band radiating elements 132 have the third height H3, which is lower/shorter than the second height H2. Accordingly, some radiating elements 142 of the second mid-band array 140-2 may be mounted farther forward (in the forward direction F) than other radiating elements 142 of the second mid-band array 140-2. Moreover, FIG. 7B shows that the radiating elements 142 having the third height H3 may alternate (and be collinear) along the vertical direction V with the radiating elements 142 having the second height H2.

FIG. 7C is a schematic block diagram illustrating phase-compensation circuitry 710 that is coupled to a mid-band radiating element 142. The phase-compensation circuitry 710 may include, for example, one or more phase delay lines (and/or other phase-compensation circuitry) to compensate for differences in phase due to varying heights among a plurality of mid-band radiating elements 142.

In some embodiments, the phase-compensation circuitry 710 may be part of feed circuitry 700 that couples a radio 742 to a plurality of mid-band radiating elements 142 of the passive base station antenna 110 (FIG. 1A). As shown in FIG. 7C, at least one of the mid-band radiating elements 142 may not be coupled to any phase-compensation circuitry 710. As an example, the two mid-band radiating elements 142 shown in FIG. 7C may comprise a first mid-band radiating element 142 that is coupled to the phase-compensation circuitry 710 and a second mid-band radiating element 142 that is not coupled to any phase-compensation circuitry 710, where the first and second mid-band radiating elements 142 may have the different heights H2, H3, respectively (or vice versa), that are shown in FIG. 7A (or FIG. 7B). The phase-compensation circuitry 710 may be configured to provide phase compensation to compensate for the different heights H2, H3. Accordingly, referring to FIG. 7A, phase-compensation circuitry 710 may be coupled to the second and/or third mid-band arrays 140-2, 140-3 but not the first and/or fourth mid-band arrays 140-1, 140-4, or vice versa. Moreover, referring to FIG. 7B, phase-compensation circuitry 710 may be coupled to radiating elements 142 in the second mid-band array 140-2 having the second height H2 but not radiating elements 142 in the second mid-band array 140-2 having the third height H3, or vice versa.

Base station antennas 100 (FIG. 1A) according to embodiments of the present invention may provide a number of advantages. These advantages include reducing costs by using fewer feed stalks, due to shared feed stalks 400/500 (FIGS. 3A, 5A) of the present invention that are each coupled to multiple radiating elements (FIGS. 3A, 5A) that operate in different frequency bands. Moreover, RF performance (e.g., massive MIMO performance and/or mid-band performance) may be improved by reducing shielding on a massive MIMO area and/or on mid-band arrays.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A base station antenna comprising:
a first antenna array having a plurality of first frequency band dipole radiating elements; and
a second antenna array having a plurality of second frequency band dipole radiating elements,
wherein a first of the second frequency band dipole radiating elements is mounted on, and forward of, a first of the first frequency band dipole radiating elements.

2. The base station antenna of claim 1, wherein the first of the first frequency band dipole radiating elements and the first of the second frequency band dipole radiating elements share a feed stalk.

3. The base station antenna of claim 2, wherein the shared feed stalk extends through the first of the first frequency band dipole radiating elements to couple to the first of the second frequency band dipole radiating elements.

4. The base station antenna of claim 2, wherein the shared feed stalk comprises a printed circuit board (PCB) having:
a first feed line that is coupled to a first dipole of the first of the first frequency band dipole radiating elements; and
a second feed line that is coupled to a first dipole of the first of the second frequency band dipole radiating elements.

5. The base station antenna of claim 2.
wherein the shared feed stalk is an angled feed stalk,
wherein no feed stalk other than the shared feed stalk is coupled to the first of the first frequency band dipole radiating elements, and
wherein no feed stalk other than the shared feed stalk is coupled to the first of the second frequency band dipole radiating elements.

6. The base station antenna of claim 2, further comprising a metal layer on the feed stalk that extends in parallel to dipole radiators of the first of the first frequency band dipole radiating elements.

7. The base station antenna of claim 6, wherein the metal layer comprises a frequency selective surface (FSS).

8. The base station antenna of claim 7, further comprising a third antenna array having a plurality of third frequency band radiating elements that are mounted rearward of the FSS.

9. The base station antenna of claim 8,
wherein the FSS is a first FSS, and
wherein the base station antenna further comprises a second FSS that is between the third frequency band radiating elements and the first FSS.

10-12. (canceled)

13. The base station antenna of claim 1, wherein the first frequency band dipole radiating elements are configured to operate in a lower frequency band than the second frequency band dipole radiating elements.

14-15. (canceled)

16. The base station antenna of claim 1, wherein the second antenna array is a first of a plurality of antenna arrays of the second frequency band dipole radiating elements, and is mounted farther forward than a second of the plurality of antenna arrays of the second frequency band dipole radiating elements.

17. The base station antenna of claim 16, wherein the base station antenna is configured to provide phase compensation to compensate for different heights of the second frequency band dipole radiating elements.

18. The base station antenna of claim 1, wherein the first of the second frequency band dipole radiating elements is mounted farther forward than a second of the second frequency band dipole radiating elements.

19-20. (canceled)

21. A base station antenna comprising:
a first antenna array having a plurality of first frequency band dipole radiating elements; and
a second antenna array having a plurality of second frequency band dipole radiating elements,
wherein a first of the second frequency band dipole radiating elements is fed from the same feed stalk as a first of the first frequency band dipole radiating elements, and
wherein the first frequency band dipole radiating elements are configured to operate in a lower frequency band than the second frequency band dipole radiating elements.

22. The base station antenna of claim 21, wherein the feed stalk extends through the first of the first frequency band dipole radiating elements to couple to the first of the second frequency band dipole radiating elements.

23. The base station antenna of claim 21, wherein the feed stalk comprises a printed circuit board (PCB) having:
a first feed line that is coupled to a first dipole of the first of the first frequency band dipole radiating elements; and
a second feed line that is coupled to a first dipole of the first of the second frequency band dipole radiating elements.

24-41. (canceled)

42. A base station antenna comprising:
a first antenna array having a plurality of first-band dipole radiating elements, wherein a first of the first frequency band dipole radiating elements comprises a printed circuit board (PCB) having an integrated reflector; and
a second antenna array having a plurality of second frequency band dipole radiating elements,
wherein a first of the second frequency band dipole radiating elements is mounted on the first of the first frequency band dipole radiating elements, and
wherein the first frequency band dipole radiating elements are configured to operate in a lower frequency band than the second frequency band dipole radiating elements.

43. The base station antenna of claim 42, wherein the integrated reflector comprises a frequency selective surface (FSS).

44. The base station antenna of claim 43, further comprising a third antenna array having a plurality of third-band radiating elements that are mounted rearward of the FSS.

45. The base station antenna of claim 44,
wherein the first frequency band dipole radiating elements are configured to operate in a first frequency band that is lower than a second frequency band in which the second frequency band dipole radiating elements are configured to operate,
wherein the second frequency band is lower than a third frequency band in which the third-band radiating elements are configured to operate, and
wherein the FSS is configured to allow RF energy to pass through at the third frequency band and to reflect RF energy at the second frequency band.
